(19) United States
(12) Patent Application Publication
(10) Pub. No.: US 2005/0041135 A1
(43) Pub. Date: Feb. 24, 2005

(54) Electronic imaging apparatus

(76) Inventor: Takayoshi Togino, Tokyo (JP)

Correspondence Address: KENYON & KENYON, 1500 K STREET, N.W., SUITE 700, WASHINGTON, DC, 20005, US

(21) Appl. No.: 10/916,418

(22) Filed: Aug. 12, 2004

(30) Foreign Application Priority Data
Aug. 19, 2003 (JP) 2003-294882

(51) Int. Cl. H04N 5/222

(52) U.S. Cl. 348/340

(57) ABSTRACT

The invention relates to a small-format electronic imaging apparatus. The imaging apparatus comprises a two-dimensional image pickup device 1 capable of picking up images differing with the directions of incidence thereof, and reflecting surfaces 4 and 5 for reflecting an image of at least one object toward the two-dimensional image pickup device 1. The apparatus further comprises an image-formation optical system 30 for formation of an image of an object, wherein the optical system 30 is located on an entrance side of the two-dimensional image pickup device 1 and an object side of the imaging apparatus with respect to the reflecting surfaces 4 and 5, and a stop 2 for restricting a light beam. The reflecting surfaces 4 and 5 are positioned in such a way as not to cross an optical axis 3 defined by a light ray that passes through the center of the stop 2 and arrives at the center of the two-dimensional image pickup device 1.

This application claims benefit of Japanese Application No. 2003-294882 filed in Japan on Aug. 19, 2003, the contents of which are incorporated by this reference.

### BACKGROUND OF THE INVENTION

The present invention relates generally to an electronic imaging apparatus, and more particularly to a considerably slimmed down electronic imaging apparatus with a small-format image pickup device.

Until now, electronic image pickup devices such as CCDs have decreased steadily in size with higher pixel densities. In recent years, pixel densities have become as high as can achieve pixel pitches of less than 2 μm. At a pixel pitch of less than 2 μm, however, there is a decrease in the number of photons that can be received at one pixel, even though a microlens is provided on the photoreception surface of each pixel for condensation of light, resulting in relatively more increased noises and, hence, rendering image quality worse.

Therefore, if an electronic image pickup device having 1,000×1,000 pixels is built up, the limitation to slimming down the electronic image pickup device will then be 2 mm×2 mm, given a pixel pitch of 2 μm.

### SUMMARY OF THE INVENTION

The present invention provides an electronic imaging apparatus, characterized by comprising a two-dimensional image pickup device capable of picking up an image that differs with directions of incidence thereof, and a reflecting surface for reflecting an image of at least one object toward said two-dimensional image pickup device.

It is then desired that the electronic imaging apparatus further comprise an image-formation optical system located on an entrance side of the two-dimensional image pickup device and an object side of the electronic imaging apparatus with respect to the reflecting surface, said image-formation optical system being capable of forming an object image and having positive power, and the reflecting surface be positioned in such a way as not to cross an optical axis defined by a light ray that passes through the center of a stop and arrives at the center of the two-dimensional image pickup device.

It is also desired that images picked up by the two-dimensional image pickup device be subjected to image processing such as image rotation and mirror image processing depending on their directions of incidence, and post-image-processing images be synthesized into a single frame.

Still other objects and advantages of the invention will in part be obvious and will in part be apparent from the specification.

The invention accordingly comprises the features of construction, combinations of elements, and arrangement of parts, which will be exemplified in the construction hereinafter set forth, and the scope of the invention will be indicated in the claims.

### BRIEF DESCRIPTION OF THE DRAWINGS

FIG. 1 is illustrative of the principle of the electronic imaging apparatus according to the invention.

FIG. 2 is illustrative of an extension of the arrangement of FIG. 1, wherein two plane reflecting surfaces are located parallel with an optical axis lying between them.

FIGS. 3(a) and 3(b) are a sectional view and a front view of one exemplary arrangement of the two-dimensional image pickup device capable of receiving separate images or light-quantity distributions in dependence on the directions of incidence thereof.

FIGS. 4(a) and 4(b) are a sectional view and a front view of another exemplary arrangement of the two-dimensional image pickup device capable of receiving separate images or light-quantity distributions in dependence on directions of incidence thereof.

FIG. 5 is a longitudinally sectioned view of one embodiment of the electronic imaging apparatus according to the invention.

FIG. 6 is illustrative in perspective schematic of the whole of one embodiment of the electronic imaging apparatus according to the invention.

FIG. 7 is a view similar to FIG. 5 of an arrangement wherein a plane reflecting surface is located on a side face of a truncated quadrangular prism.

FIG. 8 is a vertically sectioned optical path diagram for Example 1 of the imaging optical system used with the electronic imaging apparatus according to the invention.

FIG. 9 is a vertically sectioned optical path diagram for Example 2 of the imaging optical system used with the electronic imaging apparatus according to the invention.

FIG. 10 is a vertically sectioned optical path diagram for Example 3 of the imaging optical system used with the electronic imaging apparatus according to the invention.

### DESCRIPTION OF THE PREFERRED EMBODIMENTS

The principle of the electronic imaging apparatus according to the invention is now explained.

One feature of the invention lies in the use of a two-dimensional image pickup device capable of receiving a light-quantity distribution that differs with the direction of incidence of light. Notice here that the term “light-quantity distribution” includes that across a light beam, to say nothing of that across an image. At least one reflecting surface is located on the entrance side of the two-dimensional image pickup device having such properties and at a position off the front thereof, so that a light-quantity distribution image at least twice as large as the photoreception surface of the two-dimensional image pickup device can be picked up.

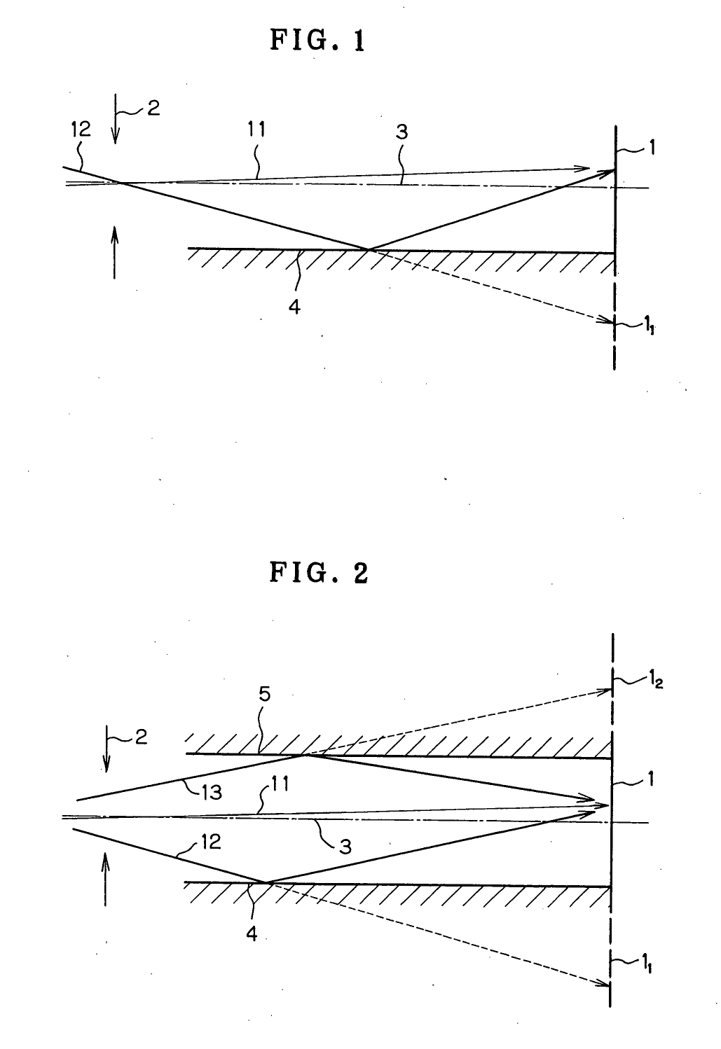

This principle is now explained with reference to FIG. 1, and FIG. 2. In an arrangement of FIG. 1, a stop 2 is located at the front of one two-dimensional image pickup device 1, and one plane reflecting surface 4 is located at a position off the front of the two-dimensional image pickup device 1 and along an optical axis 3 defined by an axis that connects the center of the two-dimensional image pickup device 1 with the center of the stop 2 (aperture). As will be explained later, it is not always necessary that the plane reflecting surface 4 be parallel with the optical axis 3.

Now suppose that the two-dimensional image pickup device 1 used herein is capable of receiving separate images or light-quantity distributions in dependence on the direction of incidence thereof. Exemplary arrangements of such a two-dimensional image pickup device 1 will be described later.

In such an arrangement, a light beam 11 that has passed through the stop (aperture) 2 from its substantially frontal direction is directly incident on the two-dimensional image pickup device 1, so that a light-quantity distribution image in a section parallel with that two-dimensional image pickup device 1 is picked up on the image pickup surface of the two-dimensional image pickup device 1.

On the other hand, a light beam 12 that has passed through the stop (aperture) 2 from a left upper site of FIG. 1 in an obliquely downward direction propagates toward the plane reflecting surface 4, whereat it is reflected. The reflected light then enters the two-dimensional image pickup device 1 from a direction of incidence different from that of the light beam 11, so that a light-quantity distribution image in a section parallel with that two-dimensional image pickup device 1 is picked up on the image pickup surface of the two-dimensional image pickup device 1.

Referring here to a light beam 12 that enters the two-dimensional image pickup device 1 upon reflection at the plane reflecting surface 4, it is tantamount to a light beam that is directly incident on a virtual image pickup surface 1₁ that is an image of the image pickup surface of the two-dimensional image pickup device 1 by the plane reflecting surface 4.

Thus, one two-dimensional image pickup device 1 and at least one reflecting surface 4 are used in such an arrangement as set forth above, whereby light-quantity distribution images across light beams incident from two different directions can be picked up at the same time.

FIG. 2 is illustrative of an extension of the arrangement of FIG. 1, wherein two plane reflecting surfaces 4 and 5 are oppositely located parallel with an optical axis 3 lying between them. More specifically, a stop 2 is positioned at the front of one two-dimensional image pickup device 1, and two plane reflecting surfaces 4 and 5 are located along and parallel with the optical axis 3 and at positions off the front of the two-dimensional image pickup device 1. In this case, light-quantity distribution images formed by light beams from three directions, i.e., those formed by light beams 12 and 13 incident through the stop (aperture) 2 on virtual image pickup surfaces 1₁ and 1₂ that are images of the image pickup surface of the two-dimensional image pickup device 1 by the plane reflecting surfaces 4 and 5 and that formed by a light beam 11 incident through the stop 2 from its substantially front direction can simultaneously be picked up by one two-dimensional image pickup device 1.

Another set of plane reflecting surface are provided on the front and back sides of the paper of FIG. 2 while they are located parallel with the optical axis 3 lying between them. This means that light beams incident on two virtual image pickup surfaces from two directions, which are images of the image pickup surface of the two-dimensional image pickup devices by the another set of plane reflecting surfaces, add up to the light beams from the above three directions. Moreover, there are light beams incident on four virtual image pickup surfaces from four directions, which are images of the image pickup surface of the two-dimensional image pickup device 1 formed by two reflections occurring between either of the plane reflecting surfaces 4, 5 and either one of the another set of two plane reflecting surfaces; that is, light beams are incident on the single two-dimensional image pickup device 1 from a total of nine directions. Thus, light-quantity distribution images across light beams from nine such directions can simultaneously be picked up on the single two-dimensional image pickup device 1.

It is noted that the number of plane reflecting surfaces located along the optical axis 3 and at positions off the front of the two-dimensional is not necessarily limited to one, two or four as mentioned above; three or five or more plane reflecting surfaces could be used.

Before giving an account of specific embodiments of the electronic imaging apparatus working on the above principle, some exemplary arrangements of the two-dimensional image pickup device 1 capable of receiving separate images or light-quantity distributions in dependence on the directions of incidence thereof are now explained.

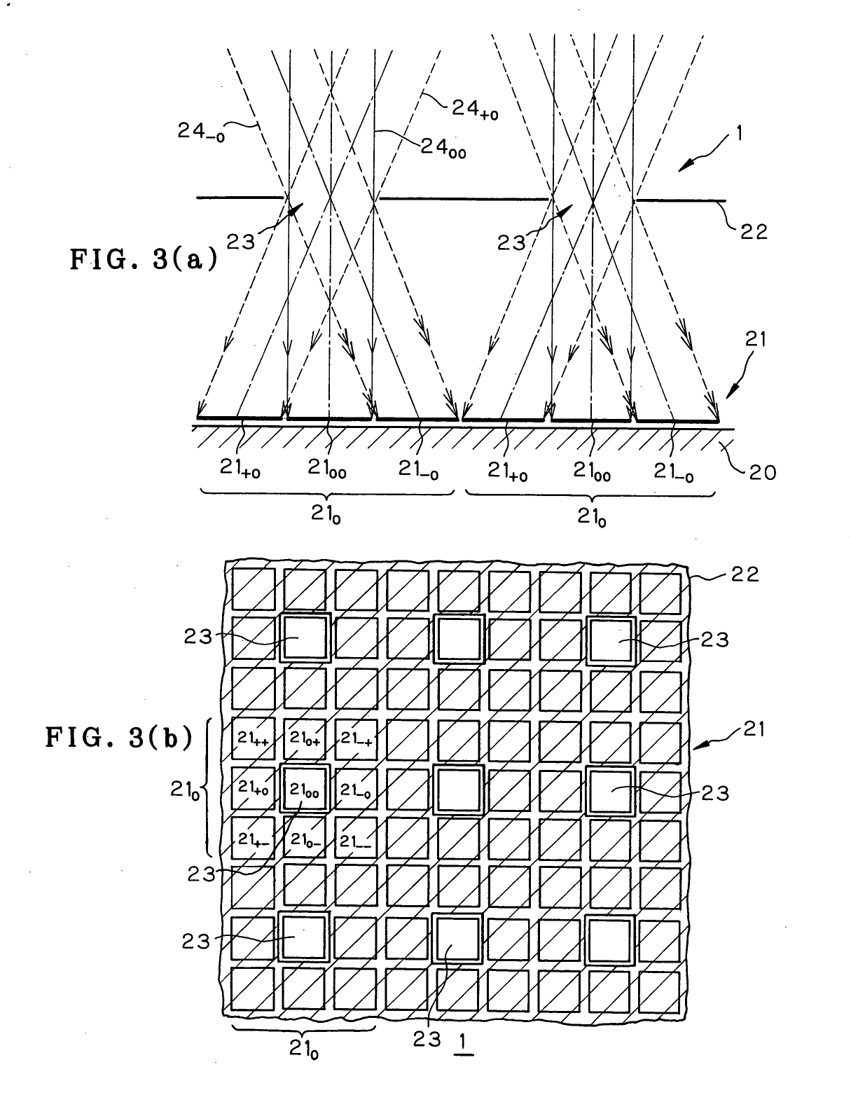

FIGS. 3(a) and 3(b) are a sectional view and a front view of one such exemplary arrangement. This two-dimensional image pickup device 1 comprises a photoreceptor unit 21 wherein photoreceptors of substantially the same size are arranged in a regular matrix form on a substrate 20, and an aperture plate 22 spaced away from the front of the photoreceptor unit 21. In this case, the photoreceptor unit 21 comprises a regular row-and-column set of unit photoreceptor groups 21₀, each composed of adjacent photoreceptors of 3×3=9. More specifically, one unit photoreceptor group 21₀ is made up of a center photoreceptor 21₀₀ and photoreceptors 21₊₊, 21₊₀, 21₊₋, 21₀₋, 21₋₋, 21₋₀, 21₋₊ and 21₀₊ disposed about it (see FIG. 3(b)).

The aperture plate 22 is provided with an aperture 23 in alignment with the position of the center photo-receptor 21₀₀ in each of the unit photoreceptor groups 21₀ in the photoreceptor unit 21, wherein the aperture 23 is substantially the same as one photoreceptor in terms of dimension and shape.

The arrangement being like this, a light beam 24₀₀ that has passed substantially vertically through each aperture 23 in the aperture plate 22 is incident on the center photoreceptor 21₀₀ at the center of an associated unit photoreceptor group 21₀. On an image pickup surface where only the photoreceptor 21₀₀ in the unit photo receptor group 21₀ is singled out as a pixel, there is thus obtained a light-quantity distribution image, sampled at the position of each photoreceptor 21₀₀, across the light beam 24₀₀ incident from the front direction of the two-dimensional image pickup device 1.

A light beam 24₋₀ that has passed through each aperture 23 in the aperture plate 22 obliquely from a left-upper site of FIG. 3(a) is incident on a right photoreceptor 21₋₀ in an associated unit photoreceptor group 21₀. On an image pickup surface where only the photoreceptor 21₋₀ in the unit photoreceptor group 21₀ is singled out as a pixel, there is thus obtained a light-quantity distribution image, sampled at the position of each photoreceptor 21₀₀, across the light beam 24₀₀ incident obliquely from a left-upper site of the two-dimensional image pickup device 1.

Likewise, a light beam 24₊₀ that has passed through each aperture 23 in the aperture plate 22 from a right-upper site of FIG. 3(a) in an oblique direction is incident on a left photoreceptor 21₊₀ in an associated unit photoreceptor group 21₀. On an image pickup surface where only the photoreceptor 21₊₀ in the unit photoreceptor subgroup 21₀ is singled out as a pixel, there is thus obtained a light-quantity distribution image, sampled at the position of each aperture, across the light beam 24₊₀ incident obliquely from a right-upper site of the two-dimensional image pickup device 1.

Likewise, on an image pickup surface where only the photoreceptor 21₊₊ in the unit photoreceptor group 21₀ is singled out as a pixel, there is obtained a light-quantity distribution image, sampled at the position of each aperture 23, across a light beam that has propagated obliquely from a front, right-lower side of the paper of FIG. 3(b) toward each aperture 23 and passed through that aperture 23.

Likewise, on an image pickup surface where only the photoreceptor 21₊₋ in the unit photoreceptor group 21₀ is singled out as a pixel, there is obtained a light-quantity distribution image, sampled at the position of each aperture 23, of a light beam that has propagated obliquely from a front, right-upper side of the paper of FIG. 3(b) toward each aperture 23 and passed through that aperture 23.

Likewise, on an image pickup surface where only the photoreceptor 21₀₋ in the unit photoreceptor group 21₀ is singled out as a pixel, there is obtained a light-quantity distribution image, sampled at the position of each aperture 23, across a light beam that has propagated from a front, upper side of the paper of FIG. 3(b) toward each aperture 23 and passed through that aperture 23.

Likewise, on an image pickup surface where only the photoreceptor 21₋₋ in the unit photoreceptor group 21₀ is singled out as a pixel, there is obtained a light-quantity distribution image, sampled at the position of each aperture 23, across a light beam that has propagated obliquely from a front, left-upper side of the paper of FIG. 3(b) toward each aperture 23 and passed through that aperture 23.

Likewise, on an image pickup surface where only the photoreceptor 21₋₊ in the unit photoreceptor group 21₀ is singled out as a pixel, there is obtained a light-quantity distribution image, sampled at the position of each aperture 23, across a light beam that has propagated obliquely from a front, left-lower side of the paper of FIG. 3(b) toward each aperture 23 and passed through that aperture 23.

Likewise, on an image pickup surface where only the photoreceptor 21₀₊ in the unit photoreceptor group 21₀ is singled out as a pixel, there is obtained a light-quantity distribution image, sampled at the position of each aperture 23, across a light beam that has propagated from a front-lower side of the paper of FIG. 3(b) toward each aperture 23 and passed through that aperture 23.

Thus, on the two-dimensional image pickup device 1 constructed as shown in FIGS. 3(a) and 3(b), separate images or quantity-light distributions incident from a total of nine directions, i.e., its frontal direction and eight directions about it can be picked up. To this end, it is preferable that only one of the photoreceptors 21₀₀, 21₊₊, 21₊₀, 21₊₋, 21₀₋, 21₋₋, 21₋₀, 21₋₊ and 21₀₊ (a photoreceptor at the associated position in each unit photoreceptor group 21₀) in every three photoreceptors in both the row and column directions is singled out as one frame-forming pixel, so that one image pickup frame is set up by signals obtained from those photoreceptors.

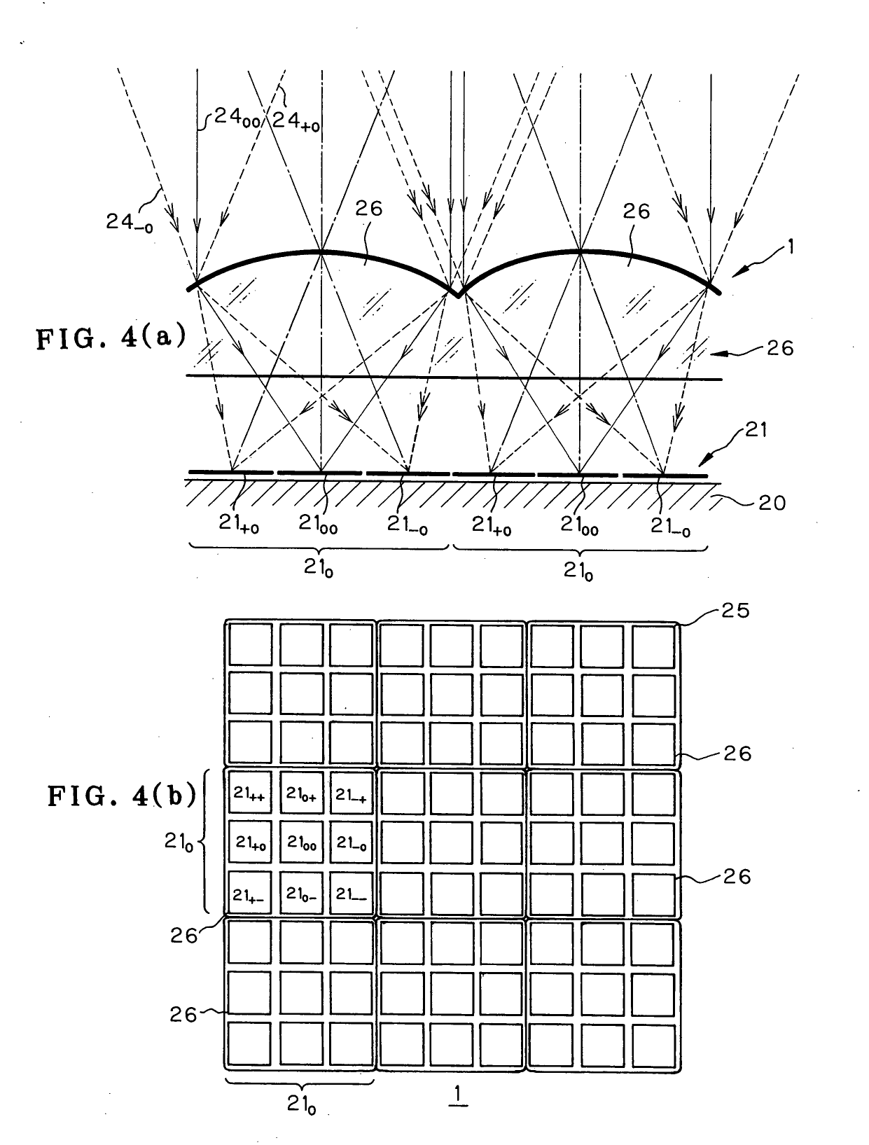

In the exemplary arrangement of FIGS. 3(a) and 3(b), the area of the aperture 23 to receive a light beam through it is barely about 1/9 of that of the unit photoreceptor group 21₀; that is, only about 1/9 of the quantity of light of the light beam incident on the photo reception surface is available whereas the remaining quantity of light is blocked off by the aperture plate 22. To solve this problem, instead of the aperture plate 22, a microlens array 25 comprising convex lenses 26, which are of substantially the same dimension and shape as those of the unit photoreceptor group 21₀ and arranged in a regular matrix form, is located in alignment with each unit photoreceptor group 21₀, with the back focus position of each convex lens 26 in line with a substantial center of the center photoreceptor 21₀₀ in the unit photoreceptor group 21₀, as shown in FIGS. 4(a) and 4(b).

In this arrangement, light beams incident from various directions toward one unit photoreceptor group 21₀ are incident substantially all over the surface of the convex lens 26; in other words, the light beam incident substantially all over the unit photoreceptor group 21₀ is condensed and entered on any one of the associated photo-receptors 21₀₀, 21₊₊, 21₊₀, 21₊₋, 21₀₋, 21₋₋, 21₋₀, 21₋₊ and 21₀₊. This ensures that nearly all the quantity of light in the light beams incident on the photoreception surface is available for image pickup purposes, so that images can be picked up with higher sensitivity than can be possible with the arrangement of FIGS. 3(a) and 3s(b).

The two-dimensional image pickup device 1 set up as shown in FIGS. 4(a) and 4(b) operates in much the same manner as explained with reference to FIG. 3(a) and 3(b); separate images or light-quantity distributions incident from a total of nine directions, i.e., the frontal direction and eight directions about it can be picked up.

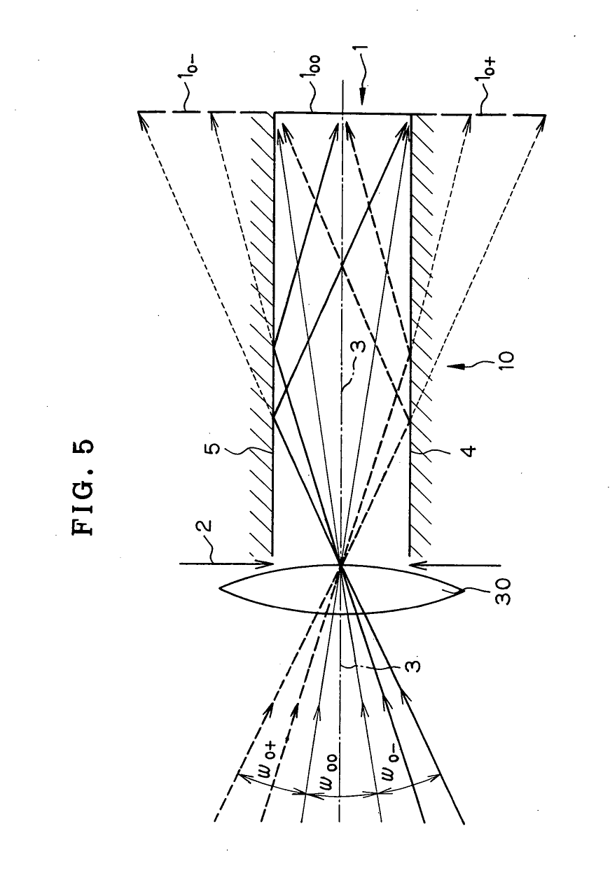

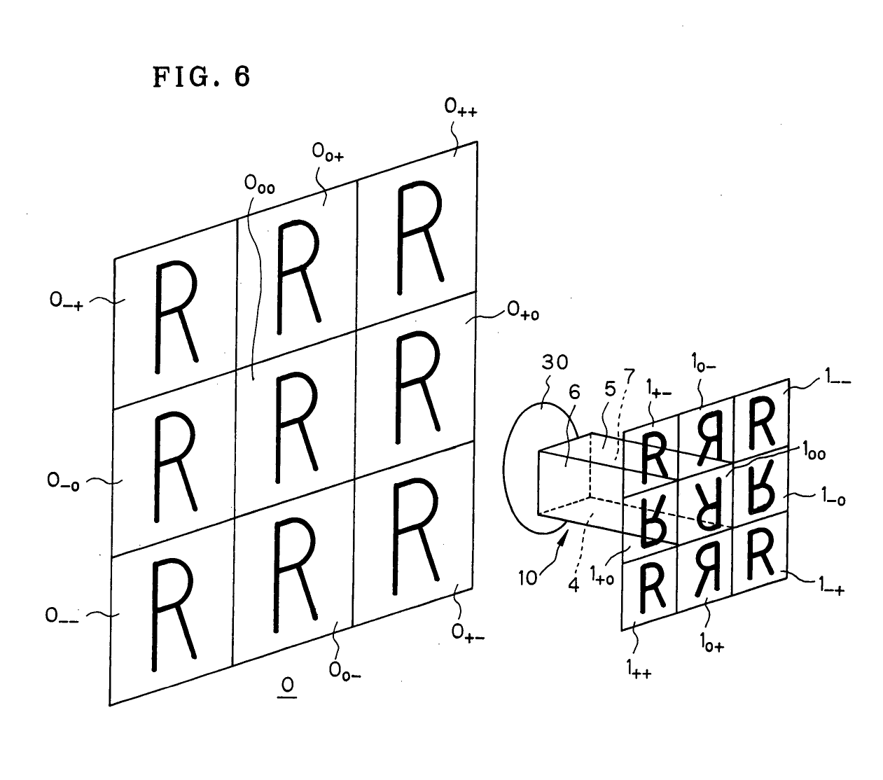

One exemplary arrangement of the electronic imaging apparatus according to the invention is now explained with reference to the longitudinally sectioned view of FIG. 5 and the general schematic perspective of FIG. 6. In this electronic imaging apparatus, a stop 2 is located at the front of a two-dimensional image pickup device 1 capable of simultaneously picking up light-quantity distribution images across light beams incident thereon from nine different directions, as shown typically in FIGS. 4(a) and 4(b). A cuboid 10 having the same rectangular shape in section as the rectangular image pickup surface of the two-dimensional image pickup device 1 with an optical axis 3 as a center axis is located in front of the two-dimensional image pickup device 1 in such a way as to come in engagement with the image pickup surface of the two-dimensional image pickup device 1 while its section is commensurate with the image pickup surface thereof. In front of the stop 2, there is provided an image-formation optical system 30 that is coaxial with the optical axis 3, with the image-formation surface of the image-formation optical system 30 in alignment with the image pickup surface of the two-dimensional image pickup device 1. Plane reflecting surfaces are defined by the surfaces 4, 5, 6 and 7 of the cuboid 10 parallel with the optical axis 3, and transmitting surfaces are defined by the surface of the cuboid 10 that faces the stop 2 and the surface of the cuboid 10 that faces the two-dimensional image pickup device 1. The plane reflecting surfaces 4 and 5 are parallel with and opposite to each other, and the plane reflecting surfaces 6 and 7 are opposite to each other and vertical to the plane reflecting surfaces 4 and 5.

Referring to the longitudinally sectioned view of FIG. 5, object light within a range of a vertically center angle of view 107 ₀₀ at which the optical axis 3 lies is incident on the image pickup surface of the two-dimensional image pickup device 1 substantially from its front to form an inverted image within that object range; object light within a range of an upstream angle of view 107 ₀₊ upstream of the center angle ω₀₀ propagates toward a virtual image pickup surface 1₀₊ that is an image of the image pickup surface of the two-dimensional image pickup device 1 by the plane reflecting surface 4, and is reflected at the plane reflecting surface 4, whence the reflected light propagates in an obliquely upward direction and enters the image pickup surface of the two-dimensional image pickup device 1 to form an erected mirror image of an object in that range; and object light within a range of a downstream angle of view ω₀-downstream of the center angle of view ω₀₀ propagates toward a virtual image pickup surface 1₀₋ that is an image of the image pickup surface of the two-dimensional image pickup device 1 by the plane reflecting surface 5, and is reflected at the plane reflecting surface 5, whence the reflecting light propagates in an obliquely downward direction and enters the image pickup surface of the two-dimensional image pickup device 1 to form an erected mirror image of an object within that range.

In the horizontal direction, too, similar image-formation occurs except that object light within the ranges of the left and right angles of view with respect to the center angle of view ω₀₀ is reflected at the plane reflecting surface 7, 6, whence the reflected light propagates toward the image pickup surface of the two-dimensional image pickup device 1 in the right-oblique direction, and in the left-oblique direction, and enters the image pickup surface to form an inverted mirror image. There is also object light that is incident from the diagonal directions of an object plane, reflected twice at the mutually orthogonal plane reflecting surfaces 4 and 6, 4 and 7, 5 and 6, and 5 and 7 in this order (reflection by a right-angle double mirror) to form erected images.

How these images are formed is shown in FIG. 6. An object plane O is divided into nine equal plane areas. Here let O₀₀ be a center object plane area, O₊₊ be a right-upper object plane area, 0₊₀ be a right object plane area, O₊₋ be a right-lower object plane area, O₀₋ be a lower object plane area, O₋₋ be a left-lower object plane area, O₋₀ be a left object plane area, O₋₊ be a left-upper object plane area, and O₀₊ be an upper object plane area. Likewise, let 1₀₊ be a virtual image pickup surface for an image on the image pickup surface of the two-dimensional image pickup device 1 by the plane reflecting surface 4, 1₀₋ be a virtual image pickup surface for an image by the plane reflecting surface 5, 1₊₀ be a virtual image pickup surface for an image by the plane reflecting surface 6, 1₋₀ be a virtual image pickup surface for an image by the plane reflecting surface 7, 1₊₊ be a virtual image pickup surface for an image by the plane reflecting surfaces 4 and 6, 1₋₊ be a virtual image pickup surface for an image by the plane reflecting surfaces 4 and 7, 1₊₋ be a virtual image pickup surface for an image by the plane reflecting surfaces 5 and 6, and 1₋₋ be a virtual image pickup surface for an image by the plane reflecting surfaces 5 and 7. Also, let 1₀₀ be the image pickup surface per se of the two-dimensional image pickup device 1.

By definition, an image on the center object plane area O₀₋ is formed on the virtual image pickup surface 1₀₀, an image on the right-upper object plane area O₊₊ is formed on the virtual image pickup surface 1₊₊, an image on the right object plane area O₊₀ is formed on the virtual image pickup surface 1₀₊, an image on the right-lower object plane area O₊₋ is formed on the virtual image pickup surface 1₊₋, an image on the lower object plane area O₀− is formed on the virtual image pickup surface 1₀₋, an image on the left-lower object plane area O₋₋ is formed on the virtual image pickup surface 1₋₋, an image on the left object plane area O₋₀ is formed on the virtual image pickup surface 1₋₀, an image on the left-upper object plane area O₋₊ is formed on the virtual image pickup surface 1₋₊, and an image on the upper object plane area O₀₊ is formed on the virtual image pickup surface 1₀₊, all in the form of inverted images. As already explained, however, images saving those formed directly on the image pickup surface 1₀₀, because of being reflected once or twice at the plane reflecting surfaces 4, 5, 6 and 7, take the forms of erected mirror images, inverted mirror images or erected images, when actually formed on the image pickup surface of the two-dimensional image pickup device 1. It is here noted that the images depicted in FIG. 6 as if they were formed on the respective virtual image pickup surfaces 1₊₊, 1₊₀, 1₊₋, 1₀₋, 1₋₋, 1₋₀, 1₋₊ and 1₀₊ are to indicate the orientation (attitude) of the images formed on the image pickup surface of the two-dimensional image pickup device 1 rather than to provide an illustration of how the images are actually formed.

In the arrangements of FIGS. 5 and 6, suppose that the two-dimensional image pickup device 1 of FIGS. 4(a) and 4(b) is used as the two-dimensional image pickup device 1 capable of picking up images incident thereon from nine different directions at the same time yet in a discrete fashion. Then, one two-dimensional image pickup device 1 could be regarded as having nine image pickup surfaces capable of picking up images separately and discretely. The following table summarizes the object planes O₀₀, O₊₊, O₊₀, O₊₋, O₀₋, O₋₋, O₋₀, O₋₊ and O₀₊ photo-taken on the respective image pickup surfaces constructed of the respective photoreceptors 21₀₀, 21₊₊, 21₊₀, 21₊₋, 21₀₋, 21₋₋, 21₋₀, 21₋₊ and 21₀₊ that forms the photoreceptor unit 21 on the photoreception surface of the two-dimensional image pickup device 1, how the states of images on the respective object planes to be phototaken are differentiated from one another, the type of image processing to be applied to the picked up images at an image processing circuit connected to the two-dimensional image pickup device 1, and how the respective images are positioned on one frame to which they are synthesized after image processing.

| | Object Plane To | |
|---|---|---|
| Photoreceptor | Be Phototaken | Image State |
| 21₀₀ | O₀₀ | Inverted Image |
| 21₊₊ | O₊₊ | Erected Image |
| 21₊₀ | O₊₀ | Inverted Mirror Image |
| 21₊₋ | O₊₋ | Erected Image |
| 21₀₋ | O₀₋ | Erected Mirror Image |
| 21₋₋ | O₋₋ | Erected Image |
| 21₋₀ | O₋₀ | Inverted Mirror Image |
| 21₋₊ | O₋₊ | Erected Image |
| 21₀₊ | O₀₊ | Erected Mirror Image |

| | | Image Position On |
|---|---|---|
| Photoreceptor | Image Processing | Frame |
| 21₀₀ | Not Applied | Center |
| 21₊₊ | 180° Rotation | Left-Lower |
| 21₊₀ | Horizontal Mirror Image | Left |
| 21₊₋ | 180° Rotation | Left-Upper |
| 21₀₋ | Vartical Mirror Image | Upper |
| 21₋₋ | 180° Rotation | Right-Upper |
| 21₋₀ | Horizontal Mirror Image | Right |
| 21₋₊ | 180° Rotation | Right-Lower |
| 21₀₊ | Vartical Mirror Image | Lower |

Such image processing and synthesis of partial frame ensure that a large-frame image can be picked up even with the use of the small-format two-dimensional image pickup device 1.

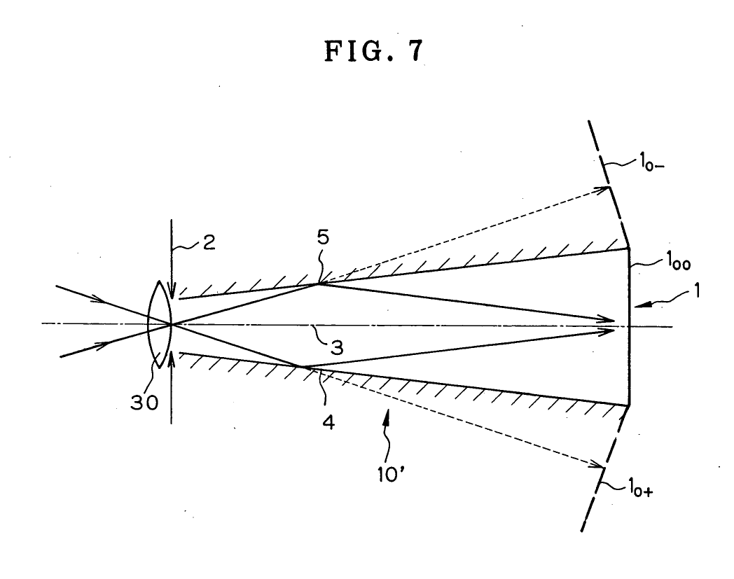

Referring further to the plane reflecting surfaces 4, 5, 6 and 7 interposed between the stop 2 and such a two-dimensional image pickup device 1 as explained above in the electronic imaging apparatus of the invention, they are not always required to be parallel with the optical axis 3, as shown in FIGS. 5 and 6; they could be constructed of the side faces of a truncated quadrangular pyramid 10′ with an optical axis 3 as the center axis, as shown in FIG. 7. In this case, too, the bottom face of the truncated quadrangular pyramid 10′ takes the same rectangular shape as the rectangular image pickup surface of the two-dimensional image pickup device 1, and is aligned and engaged with the image pickup surface of the two-dimensional image pickup device 1. Accordingly, the plane reflecting surfaces 4 and 5 are positioned vertically to the plane reflecting surfaces 6 and 7, and the mutually opposite plane reflecting surfaces 4 and 5, and 6 and 7 are positioned symmetrically with respect to the optical axis rather than parallel with each other.

However, when such plane reflecting surfaces 4, 5, 6 and 7 not parallel with the optical axis 3 are positioned in front of the two-dimensional image pickup device 1, virtual image pickup surfaces 1₀₊, 1₀₋, etc. that are images of the image pickup surface of the two-dimensional image pickup device 1 by the plane reflecting surfaces 4, 5, etc. are not on the same surface as the image pickup surface 1₀₀ of the two-dimensional image pickup device 1; they are positioned contiguously with a spherical surface with its center defined by the center of the stop 2. It is thus desired that an image-formation optical system with its image plane having substantially the same properties as those of that spherical surface be used as the image-formation optical system 30.

While, in FIGS. 5, 6 and 7, four plane reflecting surfaces are positioned in front of the two-dimensional image pickup device 1 and along the optical axis 3, it is understood that two opposite plane reflecting surfaces could be provided in such a way as to form virtual image pickup surfaces in one direction or, alternatively, three plane reflecting surfaces of regular triangle shape in section could be positioned about the optical axis 3.

Moreover, these plane reflecting surfaces could be provided on the side faces of a cuboid made of a transparent medium such as glass or plastics, or the like. This ensures that the plane reflecting surfaces are stabilized in terms of position and angle relations, and a mirror element such as the cuboid 10 or the truncated quadrangular pyrmid 10′) becomes easy to fabricate.

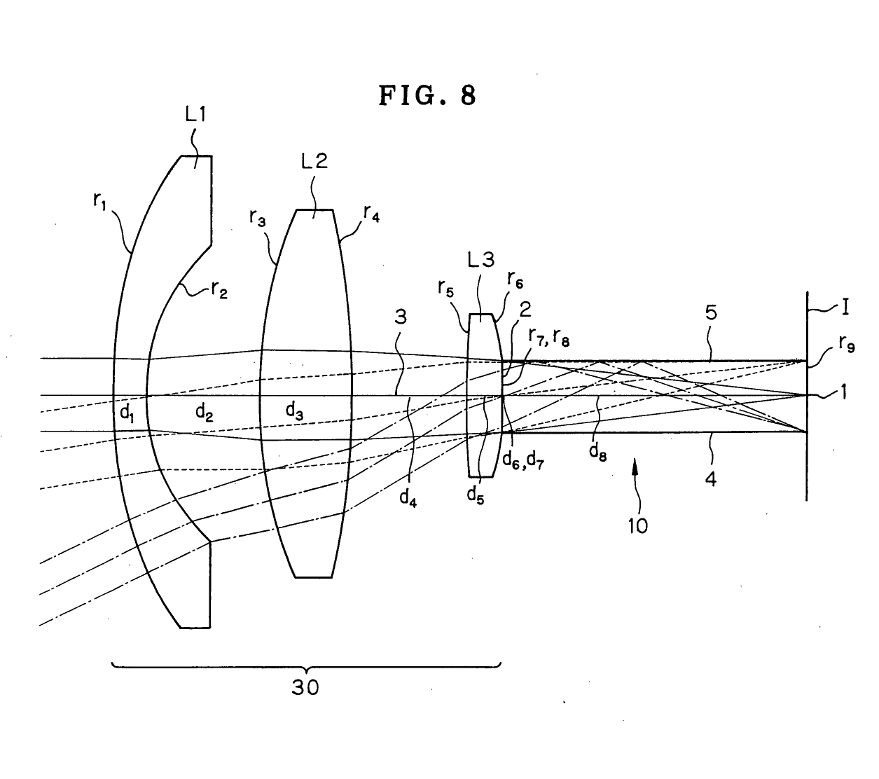

The imaging optical system used with the electronic imaging apparatus of the invention are embodied as in Examples 1, 2 and 3. FIGS. 8, 9 and 10 are vertical sectional views illustrative of optical paths for the imaging optical systems used in Examples 1, 2 and 3, respectively. In each example, the focal length of an image-formation optical system 30 is normalized at 1 mm, and plane reflecting surfaces located on the image side of a stop 2 are positioned on the side faces of a cuboid 10, which are parallel with an optical axis 3 (see FIG. 6).

### EXAMPLE 1

As shown in the vertical sectional view of FIG. 8, there is provided an image-formation optical system 30 made up of a negative meniscus lens L1 convex on its object side, a double-convex positive lens L2 and a double-convex positive lens L3. On the image side of this image-formation optical system 30, there is positioned a cuboid 10 having a horizontal length of 0.448 mm vertical to an optical axis, a vertical length of 0.336 mm and an axial length of 1.492 mm, which is axially engaged with the image side-surface of the double-convex positive lens L3. A stop 2 is located on the entrance side-plane of the cuboid 10, and four side faces of the cuboid 10 parallel with the optical axis provide plane reflecting surfaces 4, 5, 6 and 7. A two-dimensional image pickup device 1 having an image pickup surface sized to 0.448 mm in the horizontal direction and 0.336 mm in the vertical direction is engaged with the exit side-plane of the cuboid 10. Image areas of the image pickup surface of the two-dimensional image pickup device 1 delimited by the plane reflecting surfaces 4, 5, 6 and 7 form together a design image pickup surface I sized to 1.343 mm in the horizontal direction and 1.007 mm in the vertical direction. It is noted that aspheric surfaces are used, one for the object side-surface of the negative meniscus lens L1 in the image-formation optical system 30, and another for the object side-surface of the double-convex positive lens L2 nearer to the object side thereof.

### EXAMPLE 2

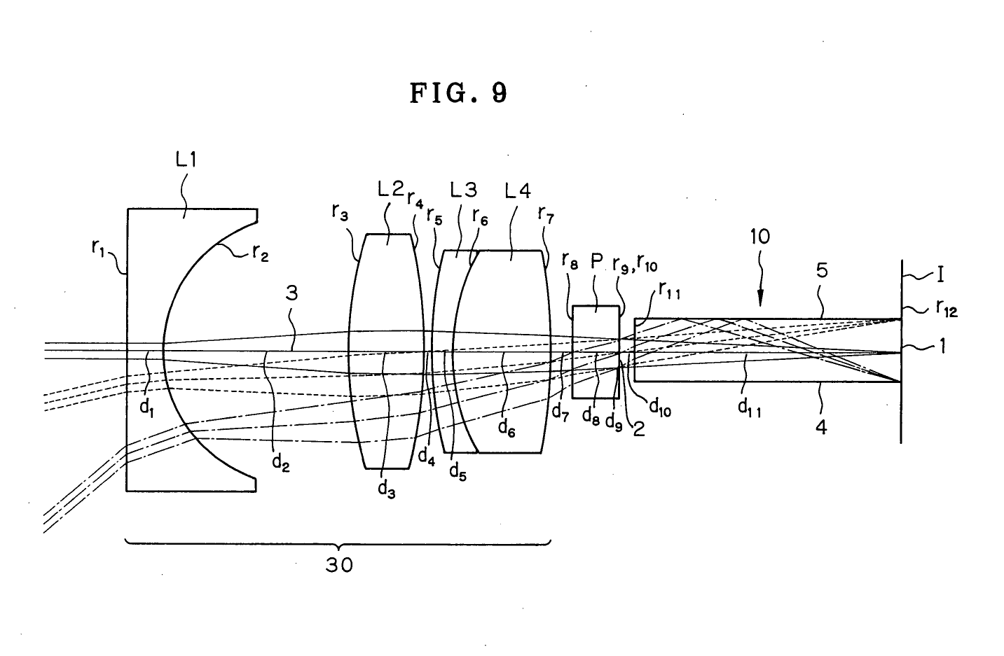

As shown in the vertical sectional view of FIG. 9, there is provided an image-formation optical system 30 made up of a plano-concave negative lens L1, a double-convex positive lens L2 and a doublet consisting of a negative meniscus lens L3 convex on its object side and a double-convex positive lens L4. On the image side of the image-formation optical system 30, there is provided a plane-parallel plate P, and on the image side of the plate P, there is provided a cuboid 10 having a horizontal length of 0.570 mm vertical to an optical axis, a vertical length of 0.496 mm and an axial length of 2.096 mm, with a stop 2 located on the image side-plane of the plane-parallel plate P. Four side faces of the cuboid 10 parallel with the optical axis provide plane reflecting surfaces 4, 5, 6 and 7. A two-dimensional image pickup device 1 having an image pickup surface sized to 0.570 mm in the horizontal direction and 0.496 mm in the vertical direction is engaged with the exit side-plane of the cuboid 10. Image areas of the image pickup surface of the two-dimensional image pickup device 1 delimited by the plane reflecting surfaces 4, 5, 6 and 7 form together a design image pickup surface I sized to 1.710 mm in the horizontal direction and 1.488 mm in the vertical direction.

### EXAMPLE 3

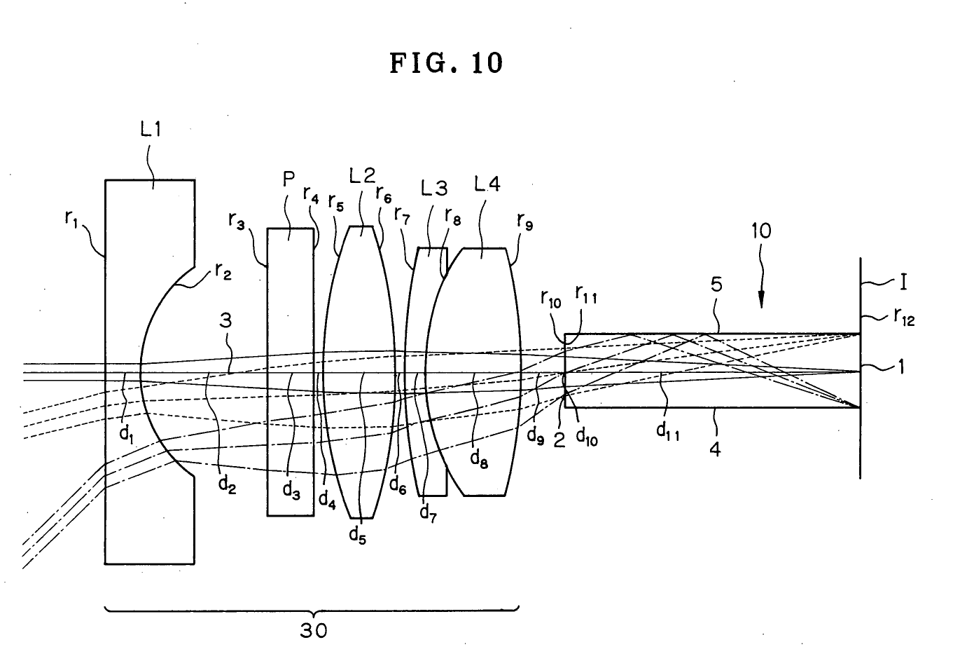

As shown in the vertical sectional view of FIG. 10, there is provided an image-formation optical system 30 made up of a plano-concave negative lens L1, a plane-parallel plate P, a double-convex positive lens L2 and a doublet consisting of a negative meniscus lens L3 convex on its object side and a double-convex positive lens L4. On the image side of the image-formation optical system 30, there is provided a cuboid 10 having a horizontal length of 0.570 mm vertical to an optical axis, a vertical length of 0.496 mm and an axial length of 2.36 mm, with a stop 2 located on the entrance side-plane of the cuboid 10. Four side faces of the cuboid 10 parallel with the optical axis provide plane reflecting surfaces 4, 5, 6 and 7. A two-dimensional image pickup device 1 having an image pickup surface sized to 0.570 mm in the horizontal direction and 0.496 mm in the vertical direction is engaged with the exit side-plane of the cuboid 10. Image areas of the image pickup surface of the two-dimensional image pickup device 1 delimited by the plane reflecting surfaces 4, 5, 6 and 7 form together a design image pickup surface I sized to 1.710 mm in the horizontal direction and 1.488 mm in the vertical direction.

Set out below are the numerical data on each example, in which the symbols mentioned hereinafter but not herein-before have the following meanings.
r₁, r₂, . . . : the radius of curvature of each lens,
d₁, d₂, . . . : a spacing between adjacent lens surfaces,
n_{d1}, n_{d2}, . . . : the d-line refractive index of each lens, and
ν_{d1}, ν_{d2}, . . . : the Abbe constant of each lens.
   Here let x be an optical axis with the proviso that the direction of propagation of light is positive, and y be a direction orthogonal to the optical axis. Then, aspheric shape is given by
   x=(y²/r)/[1+{1−(K+1)(y/r)²}^{1/2}]+A₄y⁴+A₆y⁶+A₈y⁸+A₁₀y¹⁰
   Where r is an axial radius of curvature, K is a conical coefficient, and A₄, A₆, A₈ and A₁₀ are the 4^{th}, 6^{th}, 8^{th} and 10^{th} order aspheric coefficients, respectively. It is noted that r₀ is an object plane, and d₀ is a distance from the object plane to the first surface.

### EXAMPLE 1

Focal Length 1.000
F-number 2.344
Half Angle of View Horizontal Plane 33.87° × Vartical Plane 26.72°

| | | | |
|---|---|---|---|
| r₀ = ∞ (Object plane) | d₀ = ∞ | | |
| r₁ = 3.436 (Aspheric) | d₁ = 0.16 | n_{d1} = 1.6204 | ν_{d1} = 60.3 |
| r₂ = 0.925 | d₂ = 0.54 | | |
| r₃ = 1.463 (Aspheric) | d₃ = 0.47 | n_{d2} = 1.7200 | ν_{d2} = 42.0 |
| r₄ = −3.981 | d₄ = 0.58 | | |
| r₅ = 5.628 | d₅ = 0.19 | n_{d3} = 1.7440 | ν_{d3} = 44.8 |
| r₆ = −1.372 | d₆ = 0.00 | | |
| r₇ = ∞ (Stop) | d₇ = 0.00 | | |
| r₈ = ∞ | d₈ = 1.49 | n_{d4} = 1.5163 | ν_{d4} = 64.1 |
| r₉ = ∞ (Image plane) | | | |

Aspherical Coefficients

1 st Surface
K=0
A₄=2.5217×10⁻¹
A₆=−2.1920×10⁻¹
A₈=7.3838×10⁻²
A₁₀=0

3 rd Surface
K=0.0000
A₄=−4.7169×10⁻¹
A₆=6.5741×10⁻¹
A₈=−3.8101×10⁻¹
A₁₀=0

### EXAMPLE 2

Focal Length 1.000
F-number 6.796
Half Angle of View Horizontal Plane 55.00° × Vartical Plane 40.01°

| | | | |
|---|---|---|---|
| r₀ = ∞ (Object plane) | d₀ = 7.46 | | |
| r₁ = ∞ | d₁ = 0.29 | n_{d1} = 1.8830 | ν_{d1} = 40.7 |
| r₂ = 1.03 | d₂ = 1.48 | | |
| r₃ = 2.77 | d₃ = 0.62 | n_{d2} = 1.7725 | ν_{d2} = 49.6 |
| r₄ = −3.77 | d₄ = 0.06 | | |
| r₅ = 2.96 | d₅ = 0.17 | n_{d3} = 1.8467 | ν_{d3} = 23.8 |
| r₆ = 1.47 | d₆ = 0.81 | n_{d4} = 1.6968 | ν_{d4} = 55.5 |
| r₇ = −4.37 | d₇ = 0.18 | | |
| r₈ = ∞ | d₈ = 0.39 | n_{d5} = 1.5229 | ν_{d5} = 59.9 |
| r₉ = ∞ | d₉ = 0.00 | | |
| r₁₀ = ∞ (Stop) | d₁₀ = 0.10 | | |
| r₁₁ = ∞ | d₁₁ = 2.10 | n_{d6} = 1.5163 | ν_{d6} = 64.1 |
| r₁₂ = ∞ (Image plane) | | | |

### EXAMPLE 3

Focal Length 1.000
F-number 6.796
Half Angle of View Horizontal Plane 55.00° × Vartical Plane 40.01°

| | | | |
|---|---|---|---|
| r₀ = ∞ (Object plane) | d₀ = 7.47 | | |
| r₁ = ∞ | d₁ = 0.29 | n_{d1} = 1.8830 | ν_{d1} = 40.7 |
| r₂ = 0.97 | d₂ = 1.05 | | |
| r₃ = ∞ | d₃ = 0.39 | n_{d2} = 1.5229 | ν_{d2} = 59.9 |
| r₄ = ∞ | d₄ = 0.06 | | |
| r₅ = 2.77 | d₅ = 0.62 | n_{d3} = 1.7725 | ν_{d3} = 49.6 |
| r₆ = −3.37 | d₆ = 0.06 | | |
| r₇ = 3.43 | d₇ = 0.17 | n_{d4} = 1.8467 | ν_{d4} = 23.8 |
| r₈ = 1.60 | d₈ = 0.81 | n_{d5} = 1.6968 | ν_{d5} = 55.5 |
| r₉ = −3.51 | d₉ = 0.39 | | |
| r₁₀ = ∞ (Stop) | d₁₀ = 0.00 | | |
| r₁₁ = ∞ | d₁₁ = 2.36 | n_{d6} = 1.5163 | ν_{d6} = 64.1 |
| r₁₂ = ∞ (Image plane) | | | |

1. An electronic imaging apparatus, comprising a two-dimensional image pickup device capable of picking up images differing with directions of incidence thereof, and at least one reflecting surface for reflecting an image of at least one object toward said two-dimensional image pickup device.

2. The electronic imaging apparatus according to claim 1, wherein said two-dimensional image pickup device comprises an array of photoreceptors corresponding in number to images that can be picked up, and an aperture plate having an array of apertures corresponding to said photoreceptors in said first array on the same surface, said aperture plate being located at a given position on an entrance side of a photoreceptor unit.

3. The electronic imaging apparatus according to claim 1, wherein said two-dimensional image pickup device comprises an array of photoreceptors corresponding in number to images that can be picked up, and a microlens array having an array of convex lenses corresponding to said photoreceptors in said first array on the same surface, said microlens array being located at a given position on an entrance side of a photoreceptor unit.

4. The electronic imaging apparatus according to claim 1, which further comprises an image-formation optical system for formation of an image of an object, which is located on an entrance side of said two-dimensional image pickup device and an object side of said electronic imaging apparatus with respect to said reflecting surface and has positive power, and a stop for restricting a light beam, wherein said reflecting surface is located in such a way as not to cross an optical axis defined by a light ray that passes through a center of said stop and arrives at a center of said two-dimensional image pickup device.

5. The electronic imaging apparatus according to claim 3, which further comprises an image-formation optical system for formation of an image of an object, which is located on an entrance side of said two-dimensional image pickup device and an object side of said electronic imaging apparatus with respect to said reflecting surface and has positive power, and a stop for restricting a light beam, wherein said reflecting surface is located in such a way as not to cross an optical axis defined by a light ray that passes through a center of said stop and arrives at a center of said two-dimensional image pickup device.

6. The electronic imaging apparatus according to claim 1, wherein said reflecting surface comprises two opposite reflecting surfaces.

7. The electronic imaging system according to claim 1, wherein said reflecting surface comprises two sets of two opposite reflecting surfaces.

8. The electronic imaging system according to claim 1, wherein said reflecting surface is provided on a side face of a quadrangular prism.

9. The electronic imaging apparatus according to claim 1, wherein said reflecting surface is provided on a side face of a truncated quadrangular pyramid.

10. The electronic imaging apparatus according to claim 1, wherein said reflecting surface comprises three reflecting surfaces of a regular triangle shape in section.

11. The electronic imaging apparatus according to claim 1, wherein said reflecting surface is provided on a side face of a transparent medium.

12. The electronic imaging apparatus according to claim 1, wherein images picked up by said two-dimensional image pickup device are subjected to image processing such as image rotation and mirror image processing depending on directions of incidence thereof, and after said image processing, the images are synthesized into one frame.

13. An electronic imaging apparatus, comprising:
a two-dimensional image pickup device capable of picking up images that differ with directions of incidence thereof, and
a reflecting surface for reflecting an image of at least one object toward said two-dimensional image pickup device, wherein:
said two-dimensional image pickup device comprises a plurality of photoreception units, each comprising a plurality of photoreceptors, and an aperture member having a plurality of apertures provided corresponding to said photoreception units and located on an entrance side of said photoreception units, and
each of said apertures has a light-transmitting area smaller than that of an associated photoreception unit, and is positioned such that each of the photoreceptors included in said photoreception unit receives light having a different angle of incidence, which has passed through said aperture.

14. An electronic imaging apparatus, comprising:
a two-dimensional image pickup device capable of picking up images that differ with directions of incidence thereof, and
a reflecting surface for reflecting an image of at least one object toward said two-dimensional image pickup device, wherein:
said two-dimensional image pickup device comprises a plurality of photoreception units, each comprising a plurality of photoreceptors, and a condenser member having a plurality of condensers provided corresponding to said photoreception units and located on an entrance side of said photoreception units, and
each of said condensers has a light-transmitting area substantially equal to that of an associated photoreception unit, and is positioned such that light having a different angle of incidence is condensed into each photoreceptor included in said photoreception unit.
